(19) United States
(12) Patent Application Publication
(10) Pub. No.: US 2008/0125507 A1
(43) Pub. Date: May 29, 2008

(54) Reduction of VOC emissions from low density cavity filling NVH polyurethane foams

(75) Inventors: Jack W. Jenny, Pittsburgh, PA (US); David A. Radovich, Pittsburgh, PA (US); Kenneth H. Sumner, McKees Rocks, PA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/604,952

(22) Filed: Nov. 28, 2006

(51) Int. Cl. C08L 75/04; C08J 9/00

(52) U.S. Cl. 521/137

(57) ABSTRACT

This invention relates to reactive systems for the production of low density, cavity filling polyurethane foams for NVH (noise vibration and harshness) application areas in which the system exhibits reduced VOC emissions. These foams comprises an isocyanate-reactive component having a viscosity of at least about 3,000 mPa·s, at 23° C., and comprises at least one amine-initiated compound which contains isocyanate-reactive groups.

### BACKGROUND OF THE INVENTION

This invention relates to reactive systems for the production of low density, cavity filling polyurethane foams for NVH (noise vibration and harshness) application areas in which the system exhibits reduced VOC (Volatile Organic Components) emissions. These foams comprise an isocyanate-reactive component in which one or more compounds are preferably initiated with an amine group containing starter.

Low density polyurethane cavity filling foams are suitable replacements for inserted baffles to inhibit noise transmission through automotive body structures as they offer advantages in terms of cost and performance. There is, however, a perceived exposure concern relative to Volatile Organic Compound (VOC) emissions from the raw materials of the foam systems for workers in the area (e.g. automotive assembly area) where there foams are applied. VOC emissions, as are typically measured by the United States EPA Method 24, can be reduced in accordance with the present invention. In accordance with EPA Method 24, the VOC content is calculated as described in ASTM Method D3960-93, Section 10.2.1.

Fogging occurs from foams when various volatile compounds exude from the resultant foams. This is different from the presently desired reduction of VOCs which is relative to VOC emissions from systems of raw materials which are capable of producing foams. Numerous attempts to decrease the VOC emissions and thus, the fogging have been made thus far.

U.S. Pat. No. 6,803,390 discloses a method of making rigid polyurethane foams from a reactive system comprising (a) a polyisocyanate containing a prepolymer which is the reaction product of an excess of an isocyanate with at least one polyol and at least one hydroxyl-functional acrylate or methacrylate, and (b) a polyol component containing an effective amount of a blowing agent and isocyanate-reactive materials that have an average functionality of at least about 2.3 and include at least one polyol. These systems are also characterized by (c) a volume ratio of isocyanate to polyol of no greater than 10:1, and (d) a ratio of NCO to NCO-reactive groups of from about 0.8:1 to 1.5:1. It also requires that a catalyst be present in at least one of the polyisocyanate component or the polyol component. The presence of primary or secondary amine groups in the catalysts allows them to react into the resultant polymer structure and thereby decreases the level of volatile components.

U.S. Pat. Nos. 5,672,636 and 6,060,531 disclose low-fogging polyurethane foams and specific polyoxyalkylene-polyols suitable for the production of these low-fogging foams, and a process for the production of these low-fogging foams. This process comprises reacting a) at least one polyisocyanate with b) at least one polyalkylene polyol having an OH number of 30 to 500 and that is prepared by the alkoxylation of at least one initiator molecule selected from the group consisting of N,N′-bis (3-aminopropyl)ethylenediamine, tripropylenetetramine and tetrapropylenepentamine using at least one alkylene oxide and preferably ethylene oxide and/or propylene oxide, and other polyhydroxyl compounds having a functionality of 2 to 8 and an OH number of 15 to 500, and c) optionally chain extenders and/or crosslinking agents, in the presence of d) blowing agents, and, optionally, e) catalysts and f) additives.

Polyurea-polyurethane composite structures which are substantially free of volatile organic compounds are described in U.S. Pat. No. 6,617,032. These composite structures have a flexural modulus of at least 200,000 lb/in² and include a first layer (A) and a second layer (B). The first layer (A) is substantially free of volatile organic compounds and thus, does not emit VOCs into the environment. It also includes aliphatic components which are stable in ultraviolet light. In particular, layer (A) comprises the reaction product of an aliphatic polyisocyanate and a polyamine, and typically has a Shore D hardness of at least 65. The backing layer (B) is also substantially free of VOCs, and comprises a polyisocyanate component and a resin comprising at least one polyol having a theoretical functionality of at least three, and an OH number of 200 and a viscosity of 5,000 cps or less at 25° C. The VOCs described in U.S. Pat. No. 6,617,032 are also VOCs which are emitted from the product, i.e. the composite, as compared with VOCs emitted from raw materials.

Autocatalytic polyols and their use in a process for the production of low emission polyurethane products are described in U.S. Pat. No. 6,762,274. These autocatalytic polyols reduce the quantity of conventional or reactive amine catalysts and/or organometallic catalysts required, or eliminate these entirely, and thus, reduce the level of exposure of workers to amine catalysts in the atmosphere. This process comprises reacting at least one organic polyisocyanate, with a polyol composition of from 0 to 95% of a polyol having a functionality of 2 to 8 and an OH number of from 20 to 800, and from 5 to 100% by weight of at least one polyol compound having a functionality of from 1 to 8 and an OH number of from 20 to 800. The second polyol of the polyol composition is obtained by alkoxylation of at least one initiator molecule corresponding to a specific formula, or a compound which contains an alkyl amine within the polyol chain or a dialkyl amino group pendant to the polyol chain, or a hydroxyl-tipped prepolymer prepared by reacting an excess of one of these polyols with an isocyanate.

An object of the present invention was to develop a novel reactive system which exhibits low levels of VOCs (volatile organic compounds) from the raw materials of the reactive system.

### SUMMARY OF THE INVENTION

This invention relates to reactive systems suitable for low density cavity filling polyurethane foams in which the system exhibits reduced or decreased volatile organic compounds (i.e. VOCs). These reactive systems comprise (A) a polyisocyanate component and (B) an isocyanate-reactive component, in the presence of (C) at least one catalyst and (D) water, wherein the isocyanate index is from about 60 to less than about 100.

Suitable reactive system in accordance with the present invention for the production of a polyurethane foam exhibiting decreased emissions of volatile organic compounds, comprise:
(A) a polyisocyanate component comprising a polymethylene poly(phenylisocyanate) having a polymeric content of greater than or equal to 55% by weight, and a monomeric content of less than or equal to 45% by weight;
with
(B) an isocyanate-reactive component comprising
   (1) from about 50 to about 95% by weight, based on 100% by weight of (B)(1) and (B)(2), of at least one isocyanate-reactive compound having a molecular weight of from about 1,000 to about 10,000, a functionality of from about 2 to about 6 and an OH number of from about 10 to about 340;
   and
   (2) from about 50 to about 5% by weight, based on 100% by weight of (B)(1) and (B)(2), of at least one isocyanate-reactive compound having a molecular weight of from about 60 to less than 1,000, a functionality of about 2 to about 4, and an OH number of from about 110 to about 3750;
   wherein at least one of components (B)(1) and (B)(2) comprises an amine-initiated compound;
in the presence of
(C) less than about 4% by weight, based on 100% by weight of components (B), (C) and (D), of at least one catalyst;
and
(D) a blowing agent comprising water;

In accordance with the present invention, the isocyanate-reactive component preferably has a viscosity of at least about 3,000 mPa·s, and more preferably at least about 8,000 mPa·s, at 23° C. At least one of components (B)(1) and (B)(2) herein comprise an amine-initiated compound that contains isocyanate-reactive groups. In addition, the quantity of C) catalyst for the reaction between (A) the polyisocyanate component and (B) the isocyanate-reactive component is typically from about 0.5% to less than about 4% by wt., based on 100% by weight of components (B), (C) and (D).

### DETAILED DESCRIPTION OF THE INVENTION

Suitable polyisocyanate components for the reactive systems of the present invention comprise polymethylene poly(phenylisocyanates). Suitable polymethylene poly(phenylisocyanates) to be used in accordance with the present invention include those which have (i) a polymeric content of greater than or equal to 55% by weight, and (ii) a monomeric MDI content of less than or equal to 45%, with the sum of the polymeric content and of the monomeric MDI content totaling 100% by weight of the polyisocyanate. As is understood by one of ordinary skill in the art, the sum of the polymeric isocyanate content and of the monomeric isocyanate content always totals 100% by weight of the polymethylene poly(phenyl-isocyanate) component. In addition, the polymethylene poly(phenylisocyanate) component should contain less than or equal to 10% by weight of the 2,4′-isomer of diphenylmethane diisocyanate, based on 100% by weight of the polyisocyanate component.

A preferred polymethylene poly(phenylisocyanate) of the present invention has (i) a polymeric content of greater than or equal to 60% by weight, and (ii) a monomeric MDI content of less than or equal to 40%, by weight, with the sum of the polymeric content and of the monomeric content totaling 100% by weight of the polyisocyanate. In this preferred polyisocyanate component, the quantity of the 2,4′-isomer of MDI should be less than or equal to 8% (more preferably less than or equal to 5% and most preferably less than or equal to 3%) by weight, based on 100% by weight of the polyisocyanate component.

In addition, the 2,2′-isomer content of the polymethylene poly(phenylisocyanate) component herein is typically less than 6% by weight, preferably less than 4% by weight, more preferably less than 2% by weight, and most preferably less than 2% by weight. These %'s by weight are also based on 100% by weight of the polyisocyanate component.

As is apparent to one skilled in the art, the sum of the % by weight of polymeric isocyanate and of the % by weight of monomeric isocyanate always totals 100% by weight of the polymethylene poly(phenylisocyanate). Also, the sum of the %'s by weight of the individual isomers (i.e. the 2,2′-, 2,4′- and/or 4,4′-isomers) of monomeric isocyanate and the % by weight of the polymeric isocyanate always totals 100% by weight of the polymethylene poly(phenylisocyanate). Thus, it is apparent that the sum of the %'s by weight of the individual isomers (i.e. the 2,2′-, 2,4′- and/or 4,4′-isomers) is equal to the % by weight of monomeric isocyanate. As an example, when the monomeric isocyanate content is 40% by weight, the sum of the % by weight of the 4,4′-isomer, the % by weight of the 2,4′-isomer and of the % by weight of the 2,2′-isomer equals 40% by weight.

The isocyanate-reactive component (B) for the present invention is preferably characterized by a viscosity of at least about 3,000 mPa·s at 23° C. It is more preferred that the isocyanate-reactive component (B) herein has a viscosity of at least about 8,000 mPa·s, at 23° C.

Suitable isocyanate-reactive components comprise (1) from about 50 to about 95%, preferably from about 65 to about 95%, more preferably from about 75 to 95% and most preferably from about 80 to 90% by weight, based on 100% by weight of (B)(1) and (B)(2), of at least one isocyanate-reactive compound having a molecular weight of from about 1,000 to about 10,000, a functionality of from about 2 to about 6 and an OH number of from about 10 to about 340; and (2) from about 5 to about 50%, preferably from about 5 to about 35%, more preferably from about 5 to about 25% and most preferably from about 10 to about 20% by weight, based on 100% by weight of (B)(1) and (B)(2), of at least one isocyanate-reactive compound having a molecular weight of from about 60 to less than about 1,000, a functionality of about 2 to about 4, and an OH number of from about 110 to about 3750. In addition, at least one of (B)(1) and (B)(2) comprises an amine-initiated compound. In a preferred embodiment of the present invention, one or more of components (B)(1) comprises an amine-initiated compound and one or more of component (B)(2) comprises an amine-initiated compound.

Component (1) of (B) the isocyanate-reactive component typically has a molecular weight of at least about 1,000 and preferably at least about 3,000. Component (1) also typically has a molecular weight of less than or equal to 10,000 and preferably of less than or equal to 8,000. Component (1) of the isocyanate-reactive component may also have a molecular weight ranging between any combination of these upper and lower values, inclusive, e.g. from about 1,000 to about 10,000 and preferably from about 3,000 to about 8,000.

Component (1) of the isocyanate-reactive component typically has a functionality of at least about 2. It is also typical that component (1) has a functionality of less than or equal to about 6, and preferably of less than or equal to about 4. The functionality of component (1) may range between any combination of these upper and lower values, inclusive, e.g. from 2 to 6 and preferably from 2 to 4.

The OH number of component (1) of the isocyanate-reactive component (B) typically is at least about 10 and preferably at least about 14. Typically, component (1) also has an OH number of less than or equal to about 340 and preferably of less than or equal to about 75. Component (1) of the isocyanate-reactive component may also have an OH number ranging between any combination of these upper and lower values, inclusive, e.g. from about 10 to about 340 and preferably from about 14 to about 75.

Component (2) of the isocyanate-reactive component (B) typically has a molecular weight of at least about 60. Component (2) also typically has a molecular weight of less than 1,000 and preferably of less than or equal to 500. Component (2) of the isocyanate-reactive component may also have a molecular weight ranging between any combination of these upper and lower values, inclusive unless otherwise specified, e.g. from about 60 to less than 1,000, and preferably from about 60 to about 500.

Component (2) of the isocyanate-reactive component typically has a functionality of at least about 2. It is also typical that component (2) has a functionality of less than or equal to about 4. The functionality of component (2) may range between any combination of these upper and lower values, inclusive, e.g. from 2 to 4.

The OH number of component (2) of the isocyanate-reactive component (B) typically is at least about 110 and preferably at least about 224. Typically, component (2) also has an OH number of less than or equal to 3750. Component (2) of the isocyanate-reactive component may also have an OH number ranging between any combination of these upper and lower values, inclusive, e.g. from about 110 to about 3750 and preferably from about 224 to about 3750.

It is preferred that the viscosity of isocyanate-reactive component (B) is at least about 3,000 mPa·s at 23° C., and more preferably at least about 8,000 mPa·s at 23° C.

In accordance with the present invention, isocyanate-reactive component (B) comprises at least one amine-initiated compound that contains isocyanate-reactive groups as part or all of components (B)(1) and/or (B)(2) as described hereinabove. Preferred amine-initiated compounds to be used as part or all of the isocyanate-reactive components (B)(1) and/or (B)(2) include those which are characterized by a viscosity of at least about 10,000 and more preferably of at least about 15,000 mPa·s at 23° C. In addition, these preferred amine-initiated compounds include those which are characterized by a viscosity of less than or equal to 25,000 mPa·s at 23° C., and more preferably of less than or equal to 20,000 mPa·s at 23° C. These amine-initiated compounds used as one or both of isocyanate-reactive components (B)(1) and/or (B)(2) herein may also have a viscosity ranging between any combination of these upper and lower values, inclusive, e.g. of at least about 10,000 to less than or equal to 25,000 mPa·s at 23° C., and more preferably of at least about 15,000 to less than or equal to about 20,000 mPa·s at 23° C.

Suitable compounds to be used as amine-initiators for preparing the amine-initiated compound (B)(1) and/or amine-initiated compound (B)(2) include, for example, anilines and other aromatic monoamines, aliphatic monoamines; N-alkylphenylene diamines, mono-, di- and trialkanolamines such as, for example, monoethanolamine, diethanolamine, triethanolamine, propanolamine, etc., tetrafunctional initiators such as ethylenediamine, propylenediamine, butylenediamine, 2,4′-2,2′- and 4,4′-methylene dianilines, toluene diamines, etc. These are preferably prepared such that these are isocyanate-reactive and have a suitable number of hydroxyl groups in the end position and have the desired molecular weight as described above. Suitable amine-initiated polyols are prepared by conventional methods, such as base-catalyzed (e.g. KOH) addition of alkylene oxides such as, for example, ethylene oxide, propylene oxide or butylene oxide, to an amine containing starter molecular (i.e. initiator). The addition of alkylene oxide(s) to the starter molecule which contains at least one amine group may be carried out simultaneously or, when different alkylene oxides are used, sequentially, to prepare block, heteric or block-heteric polyethers. Additional details are available in, for example, the books titled “Polyurethane Handbook” and “Polyurethanes: Chemistry and Technology”. As is apparent to one skilled in the art, the functionality, OH number and molecular weight of specific amine-initiated polyols determine whether these compounds are an isocyanate-reactive component (B)(1) or an isocyanate-reactive component (B)(2) in view of the requirements set forth above.

In accordance with the present invention, a preferred group of amine-initiated polyols to be used as component (B)(2) includes, for example, those amine-initiated polyols which are typically characterized by a molecular weight of at least about 100, more preferably of at least about 200, and most preferably of at least about 225. Typically, the preferred amine-initiated polyols have a molecular weight of less than or equal to about 500, more preferably of less than or equal to about 400, and most preferably of less than or equal to about 375. In addition, the preferred amine-initiated polyols may have a molecular weight between any combination of these upper and lower values, inclusive, e.g. from at least about 100 to about 500, more preferably from at least about 200 to about 400, and most preferably from at least about 225 to about 375. Such preferred amine-functional polyols are also typically characterized as having a functionality of about 2 to about 4, more preferably of about 3 to about 4 and most preferably of about 4.

In addition, the preferred amine-initiated polyols typically have an OH number of greater than about 220, more preferably of greater than about 280, and most preferably greater than or equal to about 300. These also typically have an OH number of less than or equal to about 2250, more preferably of less than or equal to about 1125, and most preferably less than or equal to about 1000. The OH numbers of the preferred amine-initiated polyols may also range between any combination of these upper and lower values, inclusive, e.g. from greater than about 220 to less than or equal to about 2250, more preferably from greater than about 280 to less than or equal to about 1125, and most preferably from greater than about 300 to less than or equal to about 1000.

These preferred amine-initiated polyols described above are suitable component for (B)(2) herein. Preferred amine compounds to be used as initiators are monoethanolamine and ethylene diamine.

In another preferred embodiment of the invention, component (B)(1) comprises an amine-initiated polyol. These amine-initiated polyols are typically characterized by a molecular weight of at least about 1000, more preferably of at least about 2000, and most preferably of at least about 3000. Typically, the preferred amine-initiated polyols have a molecular weight of less than or equal to about 6000, more preferably of less than or equal to about 5000, and most preferably of less than or equal to about 4000. In addition, the preferred amine-initiated polyols may have a molecular weight between any combination of these upper and lower values, inclusive, e.g. from at least about 1000 to about 6000, more preferably from at least about 2000 to about 5000, and most preferably from at least about 3000 to about 4000. Such preferred amine-functional polyols are also typically characterized as having a functionality of about 2 to about 4, more preferably of about 3 to about 4 and most preferably of about 4.

These preferred amine-initiated polyols for (B)(1) typically have an OH number greater than about 15, more preferably greater than about 20, and most preferably greater than about 25. These also typically have an OH number of less than or equal to about 225, more preferably of less than or equal to about 115, and most preferably less than or equal to about 75. The OH numbers of the preferred amine-initiated polyols may also range between any combination of these upper and lower values, inclusive, e.g. from greater than about 15 to less than or equal to about 225, more preferably from greater than about 20 to less than or equal to about 115, and most preferably from greater than or equal to about 25 to less than or equal to about 750.

In addition to the above preferred isocyanate-reactive components, other suitable isocyanate-reactive components include, for example, compounds which contain at least two hydrogen atom, which are reactive with isocyanate groups, and in general, have molecular weights, OH numbers and functionalities within the ranges as described above for components (B)(1) and (B)(2) respectively. Such isocyanate-reactive compounds are commonly referred to as polyols. As used herein, this is meant to include, for example, compounds containing amino groups, thio groups and/or carboxyl groups. Preferably, these are isocyanate-reactive compounds which contain isocyanate-reactive hydroxyl groups.

With regard to the higher molecular weight compounds (i.e. component (B)(1), examples of suitable compounds includes polyether polyols, polyester polyols, polymer polyols, polythioethers, polyacetals, polycarbonates, etc. such as are known per se for the manufacture of homogeneous and cellular polyurethanes and as are described in, for example, U.S. Pat. No. 4,263,408, the disclosure of which is hereby incorporated by reference.

Some examples of suitable polyether polyols to be used as (B)(1) include polyoxyethylene glycols, triols, tetrols and higher functionality polyols, polyoxypropylene glycols, triols, tetrols and higher functionality polyols, mixtures thereof, etc. It is also possible to use polyether polyols prepared from mixtures of ethylene oxide and propylene oxide. In such mixtures, the ethylene oxide and propylene oxide may be added simultaneously or sequentially to provide internal blocks, terminal blocks or random distribution of the oxyethylene groups and/or oxypropylene groups in the polyether polyol. Other suitable alkylene oxide monomers, known to those in the art, may be employed instead of or in addition to the ethylene oxide and propylene oxide including, for example, butylene oxide, styrene oxide or epichlorohydrin. Suitable starters or initiators (in addition to the amine starters previously disclosed) for these compounds include, for example, ethylene glycol, propylene glycol, diethylene glycol, dipropylene glycol, tripropylene glycol, trimethylol-propane, glycerol, pentaerythritol, sorbitol, sucrose, mixtures thereof, etc. By alkoxylation of the starter, a suitable polyether polyol for the base polyol component can be formed. The alkoxylation reaction may be catalyzed using any conventional catalyst including, for example, an alkaline compound such as potassium hydroxide (KOH) or a double metal cyanide (DMC) catalyst.

Other suitable polyols include alkylene oxide adducts of non-reducing sugars and sugar derivatives, alkylene oxide adducts of phosphorus and polyphosphorus acids, alkylene oxide adducts of polyphenols, polyols prepared from natural oils such as, for example, castor oil, oxidized soybean oil, etc., and alkylene oxide adducts of polyhydroxyalkanes other than those described above.

Illustrative alkylene oxide adducts of polyhydroxyalkanes include, for example, alkylene oxide adducts of 1,3-dihydroxypropane, 1,3-dihydroxybutane, 1,4-dihydroxybutane, 1,4-, 1,5- and 1,6-dihydroxyhexane, 1,2-, 1,3-, 1,6- and 1,8-dihydroxyoctant, 1,10-dihydroxydecane, glycerol, 1,2,4-trihydroxybutane, 1,2,6-trihydroxyhexane, 1,1,1-trimethylolethane, 1,1,1-trimethylolpropane, pentaerythritol, caprolactone, polycaprolactone, xylitol, arabitol, sorbitol, mannitol, and the like.

In accordance with the invention, it is preferred that at least part of (B)(1) comprises a polymer polyol, a filled polyol, a graft copolymer, a PHD polyol or other similar such polyol component which comprises a dispersion of solids in a suitable base polyol. Of these, polymer polyols are preferred.

More specifically, it is preferred that the dispersed solids within the polymer polyols are comprised of styrene-acrylonitrile (SAN) polymer. Polymer polyols are typically prepared by the in-situ polymerization of one or more vinyl monomers, also referred to as ethylenically unsaturated monomers, preferably acrylonitrile and styrene, in a base polyol, preferably a poly(oxyalkylene) polyol, having a minor amount of natural or induced unsaturation. Another preferred polymer polyol is prepared by the in-situ polymerization of styrene, acrylonitrile and vinylidene chloride in the base polyol. Polymer polyols and methods for preparing them are known and described in, for example, U.S. Pat. Nos. 3,304,273; 3,383,351; 3,523,093; 3,652,639; 3,823,201; 4,104,236; 4,111,865; 4,119,586; 4,125,505; 4,148,840; 4,172,825; 4,524,157; 4,690,956; Re-28,715; and Re-29,118, the disclosures of which are hereby incorporated by reference.

In accordance with the present invention, the most preferred polymer polyols include SAN polymer polyols which are typically prepared by the in-situ polymerization of a mixture of acrylonitrile and styrene in a base polyol. When used, the ratio of styrene to acrylonitrile polymerized in-situ in the polyol is typically in the range of from about 100:0 to about 0:100 parts by weight, based on the total weight of the styrene/acrylonitrile mixture, and preferably from 80:20 to 20:80 parts by weight.

Suitable isocyanate-reactive components to be used as component (B)(2) herein include compounds that satisfy the molecular weight, functionality and OH number ranges as set forth above. These compounds may also contain hydroxyl groups or amine groups as the isocyanate-reactive groups, and may be started from hydroxyl containing compounds or amine containing compounds as initiators. These low molecular weight compounds serve as chain extenders and/or crosslinking agents in the reaction. Any of the above identified amine containing compounds are obviously suitable as initiators for component (B)(2). Examples of such compounds which can also be part or all of component (B)(2) include ethylene glycol, propylene glycol, diethylene glycol, dipropylene glycol, tripropylene glycol, trimethylolpropane, glycerol, pentaerythritol, sorbitol, sucrose, 1,3-dihydroxypropane, 1,3-dihydroxybutane, 1,4-dihydroxybutane, 1,4-, 1,5- and 1,6-dihydroxyhexane, 1,2-, 1,3-, 1,6- and 1,8-dihydroxyoctane, 1,10-dihydroxydecane, glycerol, 1,2,4-trihydroxybutane, 1,2,6-trihydroxyhexane, 1,1,1-trimethylolethane, caprolactone, polycaprolactone, xylitol, arabitol, mannitol, etc. Higher molecular weight adducts of these may also be suitable as (B)(2) components, provided the above disclosed molecular weight ranges are followed.

As is apparent to one skilled in the art, the present invention allows for one or both of components (B)(1) and (B)(2) to comprise an amine-initiated polyol. At a minimum, one of (B)(1) and (B)(2) must comprise an amine-initiated polyol.

In a particularly preferred embodiment of the present invention, the isocyanate-reactive component (B)(1) comprises (a) an amine-initiated polyol and (b) a polymer polyol. It is more preferred in this particular embodiment that (B)(2) also comprise an amine-initiated polyol.

One particularly preferred embodiment comprises (B)(1) an isocyanate-reactive component comprising (a) an amine-initiated polyol having a functionality of about 4, a molecular weight of 3000 to 4000 and an OH number of greater than about 55 to less than about 75, and (b) a polymer polyol having a molecular weight of about 7000 to about 9000, a functionality of about 3 and comprising about 43% by weight of SAN solids; and (B)(2) an amine-initiated polyol having a functionality of about 3, a molecular weight of about 200 to about 300 and an OH number of about 550 to less than about 850.

Suitable catalysts to be used as component (C) in accordance with the present invention include, for example, the known amine catalysts and metal catalysts which are known in the art to be suitable for preparing polyurethane foams. Such catalysts include, but are not limited to, acid blocked amines (i.e. delayed action catalysts), amine gel catalysts, organic acid blocked tertiary amines, organic metal compounds, especially organic tin, bismuth, and zinc compounds, and including those which contain sulfur, etc.

Some examples of suitable tertiary amine catalysts include triethylamine, tributylamine, N-methylmorpholine, N-ethylmorpholine, N,N,N′,N′-tetramethylethylene diamine, pentamethyldiethylene triamine, and higher homologues (German Offenlegungsschriften 2,624,527 and 2,624,528), 1,4-diazabicyclo[2.2.1]octane, N-methyl-N′-(dimethylaminoethyl)-piperazine, bis(dimethylaminoalkyl)piperazines (German Offenlegungs-schrift 2,636,787), N,N-dimethylcyclohexylamine, N,N-diethylbenzylamine, bis(N,N-diethyl-aminoethyl)adipate, N,N,N′,N′-tetramethyl-1,3-butane-diamine, N,N,-dimethyl-β-phenylethylamine, 1,2-dimethylimidazole, 2-methylimidazole, monocyclic and bicyclic amidines (German Offen-legungsschrift 1,720,633) bis(dialkylamino)alkyl esters (U.S. Pat. No. 3,330,782 and German Auslegeschrift 030,558 and German Offenlegungsschriften 1,804,361 and 2,618,280), and tertiary amines containing amide groups (preferably formamide groups) according to German Offenlegungsschriften 2,523,633 and 2,732,292. The catalysts used may also be the known Mannich bases of secondary amines (such as dimethylamine) and aldehydes (preferably formaldehyde) or ketones (such as acetone) and phenols.

Suitable catalysts also include certain tertiary amines containing isocyanate-reactive hydrogen atoms. Examples of such catalysts include thiethanolamine, triisopropanolamine, N-methyldiethanolamine, N-ethyldiethanolamine, N,N-dimethylethanolamine, their reaction products with alkylene oxides (such as propylene oxide and/or ethylene oxide) and secondary-tertiary amines.

Other suitable catalysts include acid blocked amines (i.e. delayed action catalysts). Examples of acid-blocked amine catalysts include DABCO® 8154 catalyst based on 1,4-diazabicyclo[2.2.2]octane and DABCO® BL-17 catalyst based on bis(N,N-dimethylaminoethyl) ether (available from Air Products and Chemicals, Inc., Allentown, Pa.) and POLYCAT® SA-1, POLYCAT® SA-102, and POLYCAT® SA-610/50 catalysts based on POLYCAT® DBU amine catalyst (available from Air Products and Chemicals, Inc.) as are known and described in, for example, U.S. Pat. No. 5,973,099, the disclosure of which is herein incorporated by reference.

Examples of suitable organic acid blocked amine gel catalysts which may be employed are the acid blocked amines of triethylene-diamine, N-ethyl or methyl morpholine, N,N dimethylamine, N-ethyl or methyl morpholine, N,N dimethylaminoethyl morpholine, N-butyl-morpholine, N,N′ dimethylpiperazine, bis(dimethylamino-alkyl)-piperazines, 1,2 dimethyl imidazole, dimethyl cyclohexylamine. The blocking agent can be an organic carboxylic acid having 1 to 20 carbon atoms, preferably 1-2 carbon atoms. Examples of blocking agents include 2-ethyl-hexanoic acid and formic acid. Any stoichiometric ratio can be employed with one acid equivalent blocking one amine group equivalent being preferred. The tertiary amine salt of the organic carboxylic acid can be formed in situ, or it can be added to the polyol composition ingredients as a salt. To this end, quaternary ammonium salts are particularly useful. Such acid blocked amine catalysts are known and described in, for example, U.S. Pat. No. 6,013,690, the disclosure of which is herein incorporated by reference.

Other suitable amine catalysts include the organic acid blocked tertiary amines. Suitable organic carboxylic acids used to block the tertiary amine gel catalysts, if needed to provide a time delayed action, include mono- or dicarboxylic acids having 1-20 carbon atoms, such as formic, acetic, propionic, butyric, caproic, 2-ethyl-hexanoic, caprylic, cyanoacetic, pyruvic, benzoic, oxalic, malonic, succinic, and maleic acids, with formic acid being preferred.

The delayed action gel catalysts may be fully blocked or partially blocked with an organic carboxylic acid to yield a respective, blocked fully tertiary amine salt of the organic carboxylic acid or a partial salt of the organic carboxylic acid. The amount of organic carboxylic acid reacted with the tertiary amine gel catalyst depends upon the degree to which one desires to delay the tertiary amine catalytic activity.

Other acid blocked amine catalysts suitable for the present invention include those described in, for example U.S. Pat. Nos. 4,219,624, 5,112,878, 5,183,583, 6,395,796, 6,432,864 and 6,525,107, the disclosures of which are herein incorporated by reference.

Other suitable catalysts include organic metal compounds, especially organic tin, bismuth and zinc compounds. Suitable organic tin compounds include those containing sulfur, such as dioctyl tin mercaptide, and, preferably, tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutyltin maleate, and dioctyltin diacetate. Suitable bismuth compounds include bismuth neodecanoate, bismuth versalate, and various bismuth carboxylates known in the art. Suitable zinc compounds include zinc neodecanoate and zinc-versalate. Mixed metal salts containing more than one metal (such as carboxylic acid salts containing both zinc and bismuth) are also suitable catalysts.

Further representatives of catalysts to be used according to the invention and details concerning their mode of action are described in Kunstoff Handbuch, Volume VII, published by Vieweg and Hochtlen, Carl-Hanser-Verlag, Munich, 1966, for example, on pages 96-102.

In accordance with the present invention, one factor found to assist in reducing VOCs is the quantity of catalyst present. Thus, in accordance with the present invention, the quantity of catalyst used as component C) herein typically is less than about 4%, preferably less than about 3%, and more preferably less than about 2.5% by weight, based on 100% by weight of components (B), (C) and (D). In addition, the quantity of catalyst used as component C) herein typically is at least about 0.5% by weight, and preferably at least about 1% by weight, based on 100% by weight of components (B), (C) and (D). The catalyst may be present in an amount ranging between any combination of these lower and upper quantities, inclusive, e.g. from 0.5% to less than 4%, preferably from 0.5% to less than 3%, and more preferably from about 1% to less than about 2.5% by weight, based on 100% by weight of components (B), (C) and (D).

Component (D) of the present invention is a blowing agent that comprises water. It is preferred that the blowing agent is present in an amount of at least about 1.5% by weight, preferably at least about 2% by weight, and more preferably at least about 2.5% by weight, based on 100% by weight of the isocyanate-reactive components. It is also preferred that the blowing agent is present in an amount of less than or equal to about 10% by weight, preferably of less than or equal to about 8% by weight and more preferably less than about 6% by weight, based on 100% by weight of the isocyanate-reactive components. Thus, the % by weight of water herein may vary from about 1.5% to about 10%, preferably from about 2% to about 8%, more preferably from about 2.5% to about 6% by weight, based on 100% by weight of the isocyanate-reactive component (B).

The blowing agent should always comprise water, but can also optionally comprise other known blowing agents. This is, however, less preferred.

In accordance with the present invention, an Isocyanate Index of less than 100, preferably less than or equal to 90, more preferably less than or equal 80 and most preferably less than or equal to 75, is generally suitable. It is also preferred that the Isocyanate Index of the reactive system is at least about 60. By the term “Isocyanate Index”, also commonly referred to as the “NCO Index”, is defined as used herein as the equivalents of isocyanate divided by the total equivalents of isocyanate-reactive hydrogen containing materials, multiplied by 100.

The reactive systems of the present invention are suitable for the production of foam by mixing the polyisocyanate component with an isocyanate-reactive component and allowing the reactants to fully react and form a foam. An advantage of the present invention is that the reaction proceeds rapidly when the components are mixed at ambient to moderately elevated temperatures, such as from about 25° C. to about 45° C. and preferably from about 30° C. to about 35° C., the % by weight of water may vary from about 1.5% to about 10%, preferably from about 2.5% to about 7%, more preferably from about 4 to about 6% by weight, based on 100% by weight of the isocyanate-reactive component (B).

In applications of particular interest, the mixed polyol and isocyanate components are dispensed onto a part or assembly where localized reinforcement, corrosion protection, sound insulation or vibration damping is desired. The formulation then cures in place, typically without the addition of further heat or energy for curing. Heating can, however, be used is desired to speed the cure, provided it does not negatively effect the end product.

The density of the foam is less than or equal to about 4.0 pcf and preferably less than or equal to about 2.3 pcf. The foam typically also has a density of greater than or equal to about 1.2 pcf and preferably greater than or equal to about 1.6 pcf. The density of the foam may range between any of these upper and lower values, inclusive, e.g. from about 1.2 to about 4.0 pcf, and preferably from about 1.6 to about 2.3 pcf.

The foam of the invention can be used in a variety of applications to structurally stiffen or reinforce areas to which it is applied. Load beams, pillars, rocker panels, roof rails and headers, cross members, and the like are examples of automotive body structural components that benefit from reinforcement from the foam of this invention. Many of these components are hollow or otherwise define a cavity. In some instances, the entire cavity will be filled by the foam. In other situations, the cavity may only partially be filled to provide increased stiffness or reinforcement in some localized area. In other instances, the foam of the invention will be applied to an area where two structural members meet horizontal structural members.

The polyurethane foams formed from the reactive systems of the present invention should be capable of adhering to a variety of surfaces, including those surfaces comprised of one or more metals, carbon fiber(s), plastics and/or polymers.

Since the polyurethane foams prepared from the reactive systems of the present invention typically are cavity filling foams, the quantity of reactants used to fill a specific cavity should be sufficient to completely fill the cavity. There is typically some shrinkage that occurs. Shrinkage is acceptable in the present invention, provided that the prepared foam maintains surface contact with the surface which forms the cavity. In the present invention, this shrinkage should be less than about 1%, based on the total volume of the foam.

Generally, the reactivity of the systems of the invention should be relatively fast. In other words, these should react in less than about 20 seconds.

As used herein, the term molecular weight refers to the number average molecular weight (Mₙ) and is determined by end group analysis (OH number).

As used herein, the phrase reduced volatile organic compounds (VOCs) or decreased volatile organic compounds (VOCs) means that the system of the invention exhibits a decrease or reduction in the quantity of volatile organic compounds of the reactive components (i.e. isocyanate component and polyol component) of polyurethane foam forming systems representative of the invention when compared to other reactive components of polyurethane foam forming systems outside the scope of the invention, under the same test conditions. In accordance with the present invention, VOCs are measured in accordance with U.S. EPA Method 24, ASTM method D4017 and ASTM Method D3960-93 Section 10.2.1.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

The following components were used in the working examples of the present invention:
Isocyanate A: a polymethylene poly(phenylisocyanate) having an NCO group content of about 31%, a functionality of about 3.1, and which comprises a polymeric content of about 68.5% by weight and a monomeric content of about 31.5% by weight, in which the monomer is made up of about 3% by weight of the 2,4′-isomer and about 28.5% by weight the 4,4′-isomer.
Polyol A: a polymer polyol having a molecular weight of about 8330, a functionality of about 3, and an OH number of about 20, which contains about 43% by weight of SAN solids
Polyol B: an ethylene diamine initiated propoxylated polyether polyol having a molecular weight of about 3470, a functionality of about 3.7 and an OH number of about 60
Polyol C: a monethanolamine initiated propoxylated polyether polyether having a molecular weight of about 240, a functionality of about 3 and an OH number of about 700
Catalyst A: 70% by weight bis(2-dimethylaminoethyl)ether in 30% by weight dipropylene glycol, a blowing catalyst commercially available as Niax A-1
Surfactant A: a polysiloxane-polyether-copolymer, commercially available as Dabco DC 193
   Table 1 shows a proposed formulation of the reactive system of polyurethane foam in accordance with the invention. The VOC analysis was tested on a sample of Isocyanate A and on a sample of Polyol Blend 1.

TABLE 1

| Polyol Blend 1 | Parts by Weight |
|---|---|
| Polyol A | 64.58 |
| Polyol B | 13.46 |
| Polyol C | 13.46 |
| Catalyst A | 2.0 |
| Surfactant A | 2.0 |
| Water | 4.5 |
| Total PBW | 100 |
| Isocyanate A | 80 |
| Isocyanate Index | 72 |

A sample of Isocyanate A and a sample of Polyol Blend 1 as set forth in Table 1 above were each submitted for VOC analysis in accordance with U.S. EPA Method 24. The results for the VOC analysis are set forth below in Tables 2 and 3. The data were reported as total volatile content, solids content, density and the VOC content.

The total volatile content was determined in triplicate according to U.S. EPA Method 24. The solids (i.e. which remained after heating at 110° C. for 1 hour) were calculated from the data.

Water was not analyzed for the sample of Isocyanate A. The VOC was calculated as if the water content was zero.

The water concentration for Polyol Blend 1 was determined as described in ASTM Method D4017 (Karl Fisher Titration).

The VOC content was calculated with the above data as described in ASTM Method D3960-93.

TABLE 2
Isocyanate Analysis

| Analysis | Isocyanate A |
|---|---|
| Total Volatile Matter (includes | 1.60 wt. % |
| water) - Average⁽¹⁾ | |
| Solids Content (Nonvolatile Matter)⁽²⁾ | 98.4 wt. % |
| Water Content (by Karl Fisher | 0 wt. % |
| Titration)⁽³⁾ | |
| Nonaqueous Volatile Matter (Total | 1.60 wt. % |
| Volatile Matter Less Water)⁽⁴⁾ | |
| Density⁽⁵⁾ | 1.24 g. ml @ 25° C. |
| VOC Content Less Water | 19.8 g/l |
| (Calculated Value)⁽⁶⁾ | |

⁽¹⁾U.S. EPA Method 24
⁽²⁾Calculated from Total Volatile Matter Data
⁽³⁾ASTM D4017
⁽⁴⁾Calculated from above data
⁽⁵⁾MSDS
⁽⁶⁾ASTM D3960-93 Section 10.2.1

TABLE 3
Polyol Blend 1 Analysis

| Analysis | Polyol Blend 1 |
|---|---|
| Total Volatile Matter (includes | 7.13 wt. % |
| water) - Average⁽¹⁾ | |
| Solids Content (Nonvolatile Matter)⁽²⁾ | 92.9 wt. % |
| Water Content (by Karl Fisher | 4.60 wt. % |
| Titration)⁽³⁾ | |
| Nonaqueous Volatile Matter (Total | 2.53 wt. % |
| Volatile Matter Less Water)⁽⁴⁾ | |
| Density⁽⁵⁾ | 1.04 g. ml @ 25° C. |
| VOC Content Less Water | 27.6 g/l |
| (Calculated Value)⁽⁶⁾ | |

⁽¹⁾U.S. EPA Method 24
⁽²⁾Calculated from Total Volatile Matter Data
⁽³⁾ASTM D4017
⁽⁴⁾Calculated from above data
⁽⁵⁾MSDS
⁽⁶⁾ASTM D3960-93 Section 10.2.1

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A reactive system suitable for the production of a polyurethane foam which exhibits decreased emissions of volatile organic compounds, comprising:
(A) a polyisocyanate component comprising a polymethylene poly(phenylisocyanate) having a polymeric content of greater than or equal to 55% by weight, and a monomeric content of less than or equal to 45% by weight;
with
(B) an isocyanate-reactive component comprising
(1) from about 50% to about 95% by weight, based on 100% by weight of (B)(1) and (B)(2), of at least one isocyanate-reactive compound having a molecular weight of from about 1,000 to about 10,000, a functionality of from about 2 to about 6 and an OH number of from about 10 to about 340;
and
(2) from about 5% to about 50% by weight, based on 100% by weight of (B)(1) and (B)(2), of at least one isocyanate-reactive compound having a molecular weight of from about 60 to less than 1,000, a functionality of about 2 to about 4, and an OH number of from about 110 to about 3750; wherein at least one of (B)(1) and (B)(2) comprises an amine-initiated compound;
in the presence of
(C) less than about 4% by weight, based on 100% by weight of components (B), (C) and (D), of at least one catalyst; and
(D) a blowing agent comprising water;
wherein the isocyanate-index of the reaction system, based on the amounts of components (A), (B) and (D) is from about 60 to about 100.

2. The reactive system of claim 1, wherein (A) said polymethylene poly(phenylisocyanate) has a polymeric content of greater than or equal to 60% by weight and a monomeric content of less than or equal to 40% by weight, based on 100% by weight of the polyisocyanate.

3. The reactive system of claim 1, wherein (B) said isocyanate-reactive component comprises
(1) from about 75% to about 95% by weight, based on 100% by wt. of (B)(1) and (B)(2), of at least one isocyanate-reactive compound having a molecular weight of from about 3,000 to about 8,000, a functionality of about 2 to about 4, and an OH number of about 14 to about 75,
and
(2) from about 5% to about 25% by weight, based on 100% by weight of (B)(1) and (B)(2), of at least one isocyanate-reactive compound having a molecular weight of from about 60 to about 500 and a functionality of about 2 to 4 and an OH number of about 224 to about 3750;
wherein at least one of (B)(1) and (B)(2) comprises an amine-initiated compound.

4. The reactive system of claim 1, wherein (B)(1) comprises at least one polymer polyol.

5. The reactive system of claim 1, wherein (B)(1) and (B)(2) both comprise at least one amine-initiated polyol.

6. The reactive system of claim 1, wherein
(B)(1) comprises
(a) at least one amine-initiated polyol,
and
(b) at least one polymer polyol,
and
(B)(2) comprises at least one amine-initiated polyol.

7. A low density, cavity filling, polyurethane foam comprising:
(A) a polyisocyanate component comprising a polymethylene poly(phenylisocyanate) having a polymeric content of greater than or equal to 55% by weight, and a monomeric content of less than or equal to 45% by weight;
with
(B) an isocyanate-reactive component comprising
(1) from about 50% to about 95% by weight, based on 100% by weight of (B)(1) and (B)(2), of at least one isocyanate-reactive compound having a molecular weight of from about 1,000 to about 10,000, a functionality of from about 2 to about 6 and an OH number of from about 10 to about 340;
and
(2) from about 5% to about 50% by weight, based on 100% by weight of (B)(1) and (B)(2), of at least one isocyanate-reactive compound having a molecular weight of from about 60 to less than 1,000, a functionality of about 2 to about 4, and an OH number of from about 110 to about 3750; wherein at least one of (B)(1) and (B)(2) comprises an amine-initiated compound;
in the presence of
(C) less than about 4% by weight, based on 100% by weight of components (B), (C) and (D), of at least one catalyst; and
(D) a blowing agent comprising water;
wherein the isocyanate-index of the reaction system, based on the amounts of components (A), (B) and (D) is from about 60 to about 100.

8. The foam of claim 7, wherein (A) said polymethylene poly(phenylisocyanate) has a polymeric content of greater than or equal to 60% by weight and a monomeric content of less than or equal to 40% by weight, based on 100% by weight of the polyisocyanate.

9. The foam of claim 7, wherein (B) said isocyanate-reactive component comprises
(1) from about 75% to about 95% by weight, based on 100% by wt. of (B)(1) and (B)(2), of at least one isocyanate-reactive compound having a molecular weight of from about 3,000 to about 8,000, a functionality of about 2 to about 4, and an OH number of about 14 to about 75,
and
(2) from about 5% to about 25% by weight, based on 100% by weight of (B)(1) and (B)(2), of at least one isocyanate-reactive compound having a molecular weight of from about 60 to about 500 and a functionality of about 2 to 4 and an OH number of about 224 to about 3750;
wherein at least one of (B)(1) and (B)(2) comprises an amine-initiated compound.

10. The foam of claim 7, wherein (B)(1) comprises at least one polymer polyol.

11. The foam of claim 7, wherein (B)(1) and (B)(2) both comprise at least one amine-initiated polyol.

12. The foam of claim 7, wherein
(B)(1) comprises
(a) at least one amine-initiated polyol,
and
(b) at least one polymer polyol,
and
(B)(2) comprises at least one amine-initiated polyol.

13. A process for the preparation of a low density, cavity-filling polyurethane foam comprising
(A) a polyisocyanate component comprising a polymethylene poly(phenylisocyanate) having a polymeric content of greater than or equal to 55% by weight, and a monomeric content of less than or equal to 45% by weight;
with
(B) an isocyanate-reactive component comprising
(1) from about 50% to about 95% by weight, based on 100% by weight of (B)(1) and (B)(2), of at least one isocyanate-reactive compound having a molecular weight of from about 1,000 to about 10,000, a functionality of from about 2 to about 6 and an OH number of from about 10 to about 340;
and
(2) from about 5% to about 50% by weight, based on 100% by weight of (B)(1) and (B)(2), of at least one isocyanate-reactive compound having a molecular weight of from about 60 to less than 1,000, a functionality of about 2 to about 4, and an OH number of from about 110 to about 3750;
wherein at least one of (B)(1) and (B)(2) comprises an amine-initiated compound;
in the presence of
(C) less than about 4% by weight, based on 100% by weight of components (B), (C) and (D), of at least one catalyst;
and
(D) a blowing agent comprising water;
wherein the isocyanate-index of the reaction system, based on the amounts of components (A), (B) and (D) is from about 60 to about 100.

14. The process of claim 13, wherein (A) said polymethylene poly(phenylisocyanate) has a polymeric content of greater than or equal to 60% by weight and a monomeric content of less than or equal to 40% by weight, based on 100% by weight of the polyisocyanate.

15. The process of claim 13, wherein (B) said isocyanate-reactive component comprises
(1) from about 75% to about 95% by weight, based on 100% by wt. of (B)(1) and (B)(2), of at least one isocyanate-reactive compound having a molecular weight of from about 3,000 to about 8,000, a functionality of about 2 to about 4, and an OH number of about 14 to about 75,
and
(2) from about 5% to about 25% by weight, based on 100% by weight of (B)(1) and (B)(2), of at least one isocyanate-reactive compound having a molecular weight of from about 60 to about 500 and a functionality of about 2 to 4 and an OH number of about 224 to about 3750;
wherein at least one of (B)(1) and (B)(2) comprises an amine-initiated compound.

16. The process of claim 13, wherein (B)(1) comprises at least one polymer polyol.

17. The process of claim 13, wherein (B)(1) and (B)(2) both comprise at least one amine-initiated polyol.

18. The process of claim 13, wherein
(B)(1) comprises
(a) at least one amine-initiated polyol,
and
(b) at least one polymer polyol,
and
(B)(2) comprises at least one amine-initiated polyol.
